(19) United States
(12) Patent Application Publication
(10) Pub. No.: US 2003/0021487 A1
(43) Pub. Date: Jan. 30, 2003

(54) Digital fir filter for CCD imaging systems

(76) Inventor: Richard L. Baer, Los Altos, CA (US)

Correspondence Address: HEWLETT-PACKARD COMPANY, Intellectual Property Administration, P.O. Box 272400, Fort Collins, CO, 80527-2400, US

(21) Appl. No.: 09/910,726

(22) Filed: Jul. 24, 2001

(51) Int. Cl. G06K 9/40; H04N 1/409; G06T 5/00

(52) U.S. Cl. 382/260; 348/250; 358/445; 358/463

(57) ABSTRACT

A method for processing a charge couple device (CCD) image is provided comprising the steps of obtaining charge packets in response to light, processing the charge packets into an analog signal, converting the analog signal to a digital signal, and filtering the digital signal with a finite impulse response (FIR) filter.

### BACKGROUND OF THE INVENTION

1. Field of the Invention

The invention relates generally to an image processor, and more specifically to a method for processing optical light into a digital signal, such as for a digital cameras.

2. Background of the Invention

Presently, charge couple device (CCD) imaging systems are prevalent in a variety of products. A sample output section of a CCD is shown in FIG. 1. Corresponding drive and output waveforms are shown in FIG. 2. A CCD functions by generating charge packets responsive to light. By way of example, for one type of CCD, a region of silicon is doped to form a capacitor 1 with a floating contact 2. The floating contact is reset to a drain potential V_{dd} by making transistor 3 conduct, prior to each charge packet being transferred to the floating contact.

The drive and output waveforms of FIG. 2 correspond to the inputs shown in FIG. 1. V1, V2, and 0G function to move a charge packet onto the floating contact 2. 0G is typically set to a potential somewhere between a high and low potential value. V1 and V2 function as clock signals that move a charge packet over 0G to floating contact 2. For example, V1 may start out at a high potential and V2 at a low potential. V1 would thus attract stray negative potential charge packets. If V2 changes to a high potential just prior to V1 changing to a low potential, the negative charge packets will leave V1 and propagate to V2. Eventually, when V2 goes low, the negative charge packets will flow across 0G onto the floating contact 1. This is shown as an example only. The CCD could also be a three stage or more CCD. RG corresponds to the reset signal for resetting capacitor 1 to a drain potential V_{dd}. The out signal corresponds to an ideal output on line 2 of the CCD shown in FIG. 1.

The transferred charge packet partially discharges capacitor 1, thereby resulting in a voltage change across capacitor 1. The voltage change generates an analog signal which is outputted from the CCD on line 2.

Perturbations of the output analog signal on line 2 typically fall into one of three categories: (1) Johnson noise; (2) power supply noise; and (3) and 1/f noise. Johnson noise is a common phenomenon that is present when a capacitor is charged or discharged through a resistance, and is caused by thermal voltage noise present in resistors. While power supply noise can be mitigated somewhat by decoupling the power supply, it can rarely be eliminated altogether. 1/f noise is a readily known phenomenon relating to the natural behavior of transistors.

Correlated double sampling (CDS) systems are conventionally employed to mitigate the variations described above. A sample CDS system is shown in FIG. 3. A CDS functions such that two samples of the floating drain of the CCD are taken and stored in capacitors 10 and 12, respectively. The first sample Sₚ of the floating contact potential is taken in capacitor 10 after the floating contact has been reset, and prior to receiving a charge packet. The second sample S_{D} of the floating contact potential is taken in capacitor 12 after a charge packet has been transferred to the floating drain. The difference between the two samples is determined, and used to provide a measure on line 14 of the charge amplitude with the effect of at least partially canceling out the variations.

A waveform diagram for a typical CDS is shown in FIG. 4. The signal In corresponds to an ideal input signal, for example, the ideal output signal generated on line 2 of the CCD shown in FIG. 1. S_{P} and S_{D} correspond to switching signals, for sampling the signal in on capacitors 10 and 12 respectively. The signal out corresponds to an ideal output signal from the CDS on line 14, where the CDS, for example, has obtained an accurate measurement of the charge transferred to capacitor 1 of the CCD shown in FIG. 1.

A complete conventional CCD imaging system is thus shown in FIG. 5. The aforementioned CCD 20 and CDS 22 are shown connected to an analog to digital converter (ADC) 24. Problems with this conventional system stem from limited analog bandwidth within the CCD 20 and CDS 24. Ideally, each charge packet is completely transferred to the floating drain prior to the reset occurring before the next charge packet arrives. Observations made on implemented systems, however, show that a charge packet may not be entirely delivered prior to reset, resulting in some “pixel bleeding” into the next cycle. In some instances, the partial charge packet may charge the drain higher than its reset potential, resulting in a phenomenon known as the appearance of “negative light. ”

Further, pixel bleeding causes problems with the CDS 22 when a charge packet has not been completely transferred to the floating drain. The second sample may not accurately reflect the change in potential, as the sample may only include depletion from a partially transferred charge packet. Sample waveforms comparing an ideal system with infinite analog bandwidth to an actual system with limited analog bandwidth are shown in FIG. 6.

### SUMMARY OF THE INVENTION

Briefly, in a first embodiment of the present invention, a method for processing a CCD image is provided comprising the steps of obtaining charge packets in response to light, processing the charge packets into an analog signal, converting the analog signal to a digital signal, and filtering the digital signal with a finite impulse response (FIR) filter.

In a preferred first embodiment, the step of processing the charge packets comprises the steps of resetting a voltage at a diffusion contact, transporting a charge packet to the diffusion contact to create a potential, and amplifying the potential.

In a further preferred first embodiment, the method of for processing a CCD image comprises the step of performing correlated double sampling (CDS) on the analog signal prior to the step of converting the analog signal to a digital signal.

In a further preferred first embodiment, the FIR filter is an inverse filter.

In a second embodiment of the present invention, a CCD imaging system is provided comprising a charge coupled device (CCD) for generating an analog signal from light, an analog to digital converter (ADC) for converting the analog signal to a digital signal, and a finite impulse response (FIR) filter for filtering the digital signal.

In a preferred second embodiment, the CCD imaging system further comprises a correlated double sampler (CDS) for reducing variations in the analog signal prior to the ADC converting the analog signal to a digital signal.

In a further preferred second embodiment, the FIR filter is an inverse filter that boosts high frequency components of the digital signal.

In a third embodiment of the present invention, a CCD imaging system is provided comprising a charge coupled device (CCD) for generating an analog signal responsive to light, a correlated double sampler (CDS) for reducing variations in the analog signal and generating a CDS signal, an analog to digital converter (ADC) for converting the CDS signal to a digital signal, and a filter, wherein the filter subtracts values therefrom in proportion to predetermined weighted values.

In a preferred third embodiment, the filter boosts high frequency noise. In a further preferred third embodiment, the filter is an inverse filter.

### BRIEF DESCRIPTION OF THE DRAWINGS

The foregoing advantages and features of the invention will become apparent upon reference to the following detailed description and the accompanying drawings, of which:

FIG. 1 is a schematic diagram of a conventional CCD output section.

FIG. 2 is a waveform diagram of a conventional CCD output section.

FIG. 3 is a schematic diagram of a conventional CDS.

FIG. 4 is a waveform diagram of a conventional CDS.

FIG. 5 is a schematic block diagram of a conventional CCD system.

FIG. 6 is a waveform diagram comparing a conventional CCD system to an ideal CCD system.

FIG. 7 is a schematic block diagram of a CCD system according to the present invention.

FIG. 8 is a block diagram of a filter according to the present invention.

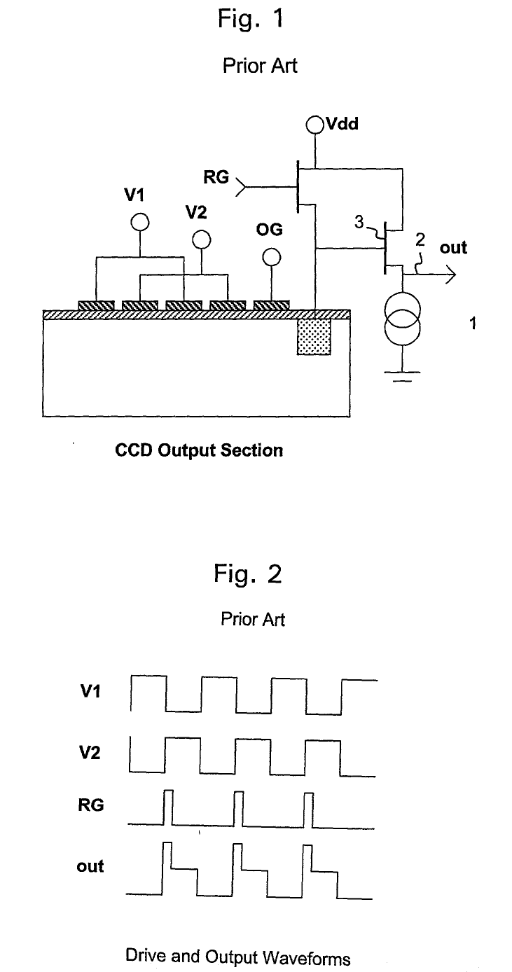

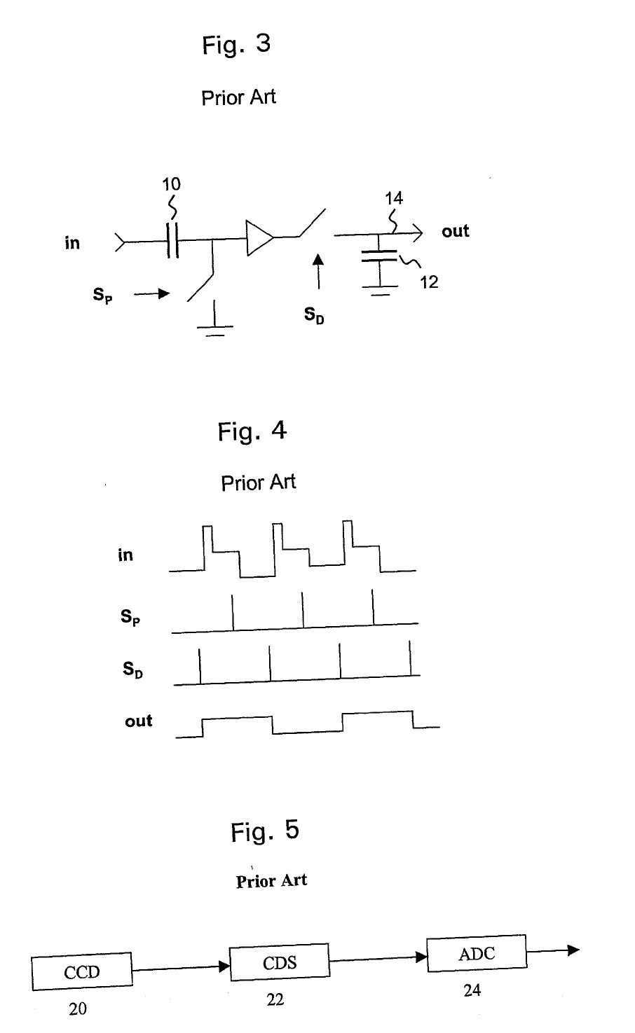

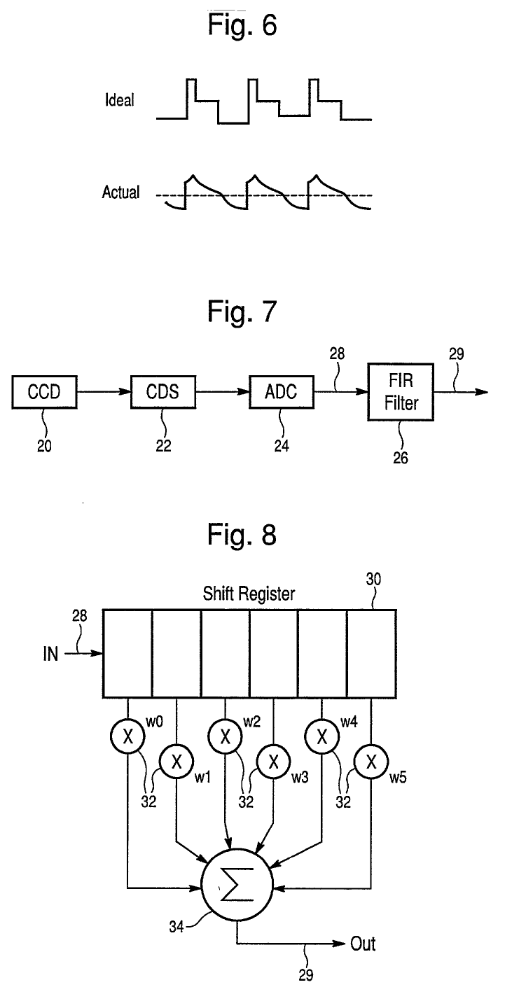

### DETAILED DESCRIPTION OF SPECIFIC EMBODIMENTS

Reference will now be made in detail to presently preferred embodiments of the invention. Wherever possible, the same reference numbers will be used throughout the drawings to refer to the same or like parts. The present invention relates generally to an image processor, more specifically to a method for processing optical light into a digital signal as used in digital cameras.

An improved CCD imaging system is shown in FIG. 7. This system includes a CCD 20 for obtaining charge packets in response to light, a CDS 22 for processing the obtained charge packets into an analog signal, and an ADC 24 for converting the analog signal to a digital signal. A preferred embodiment of the present invention further comprises a finite impulse response (FIR) filter 26 connected by line 28 to the ADC 24, and operating to filter the digital signal and output by line 29.

A preferred embodiment of the FIR filter 26 is shown in FIG. 8 and comprises shift register 30 with weighted taps 32 and an accumulator 34. Line 28 provides the input to the shift register 30. The output on line 29 is taken from the accumulator 34. Typically, the FIR filter 26 implements an inverse filter process by subtracting values in proportion to the signal levels of preceding pixels. Alternatively, the FIR filter may be implemented by a microprocessor, a DSP, or with discrete hardware for example.

In general, FIR filters can be built using a finite number of taps and delays on a digital signal. As an incoming serial digital signal enters shift register 30, each bit may be clocked in individually, and then progress through the shift register, which functions to delay each bit sequentially. Weighted taps 32 weights each bit as they progress through shift register 30. For example, weighted tap w0 may be 0, weighted tap w1 may be a 1 and so on through weighted tap w5, which may be a 5. When a bit first enters shift register 30, it would thus be weighted by 0. As the bit progresses, it would be weighted by 1, then 2, and so on until it reaches the last location in shift register 30, where it is weighted by 5. In such a configuration, a bit delayed by five would be weighted five times more than a bit delayed by 1 in the accumulator 34. By configuring the FIR filter appropriately, higher frequency components, i.e., those which occur with less delay, can be emphasized or de-emphasized in comparison to lower frequency components, i.e., those which occur with a greater delay.

In a preferred embodiment, an inverse filter implementation, such as Weiner filtering for example, introduces excess noise by boosting high frequency components of the signal on line 29. This reduces the impact of bleeding one pixel into the next. While waveform integrity may be partially degraded by introducing noise, waveform integrity is not as important as obtaining accurate potential measurements. Thus, waveform integrity is traded for improved potential measuring accuracy.

The values of, and number of weighted taps 32, in the preferred embodiment, is dependant on the desired accuracy of the system and the limited analog bandwidths of CCD 20 and CDS 22. More stages with greater weights are typically utilized to undo the effect of lower analog bandwidth relative to pixel rate. Parameter selection for FIR filter 26 is typically done after modeling the response of a conventional system (FIG. 5) to which FIR filter 26 will be added. As FIR filter 26 is typically implemented in an inverse subtracting configuration, weighted taps 32 will generally be negative in value, and in the range of less than 1.

As an example, the values of the tap weights of the filter can be determined from the impulse response of the CCD. The impulse response will comprise the set of sequential pixel values in a single row of the image array. The excitation for the impulse response measurement can be provided by one of the “hot” pixels (pixels with unusually high dark current) that are always present in a CCD. The impulse response values can be transformed into the frequency domain by using a Fourier or Z transform. The inverse filter can be created from the spatial frequency response, and then transformed back into the temporal domain in order to obtain the tap weights of the filter.

By way of example but not by way of limitation, CCD imaging systems may have 12 to 16 bit outputs. Current day maximum accuracy requirements indicate that two to three tap implementations would be sufficient. Weighting determinations for the taps 32 may be made by way of example but not by way of limitation, by studying bandwidth limitations of the conventional CCD system (FIG. 5) to be improved and empirically testing various weighted tap 32 configurations until optimal throughput is achieved.

In practice, the bandwidths of the analog circuits always exceed the pixel rate by a significant margin. Consequently the digital FIR filter only needs to be comprised of two or three stages. The exact number of stages required depends on the dynamic range that is needed. Greater accuracy is required to achieve a high dynamic range, so this method would be most beneficial in 12 to 16 bit CCD imaging systems.

Implementing FIR filter 26 into a conventional system (FIG. 5) does not necessarily require any additional equipment within a common digital device. FIR filters are typically linear filters, as are reconstruction filters which are already present in many digital platforms such as a digital camera. Thus, a linear FIR filter and linear reconstruction filter may be convolved into a single filter, that utilizes existing hardware.

Thus, improvements in processing optical light into a digital signal as may be used, for example, in digital cameras, has been described according to the present invention. Many modifications and variations may be made to the techniques and structures described and illustrated herein without departing from the spirit and scope of the invention. Accordingly, it should be understood that the methods and apparatus described herein are illustrative only and are not limiting upon the scope of the invention.

What is claimed is:

1. A method for processing a CCD image comprising the steps of:
obtaining charge packets in response to light;
processing said charge packets into an analog signal;
converting said analog signal to a digital signal; and
filtering said digital signal with a finite impulse response (FIR) filter.

2. The method of claim 1, wherein the step of processing the charge packets comprises the steps of:
resetting a voltage at a diffusion contact;
transporting a charge packet to said diffusion contact to create a potential; and
amplifying said potential.

3. The method of claim 1, further comprising the step of performing correlated double sampling (CDS) on said analog signal prior to the step of converting said analog signal to a digital signal.

4. The method of claim 1, wherein the FIR filter is an inverse filter.

5. The method of claim 4, wherein the FIR filter is a Weiner filter.

6. A CCD imaging system comprising:
a charge couple device (CCD) for generating an analog signal from light;
an analog to digital converter (ADC) for converting said analog signal to a digital signal; and
a finite impulse response (FIR) filter for filtering said digital signal.

7. The system of claim 6, further comprising: a correlated double sampler (CDS) for reducing variations in said analog signal prior to the ADC converting said analog signal to a digital signal.

8. The system of claim 6, wherein the FIR filter is an inverse filter that boosts high frequency components of the digital signal.

9. The system of claim 6, wherein the FIR filter comprises:
a shift register with weighted taps; and
an accumulator,
wherein the filter subtracts values in weighted proportion to the signal levels of previous bits.

10. A CCD imaging system comprising:
a charge couple device (CCD) for generating an analog signal responsive to light;
a correlated double sampler (CDS) for reducing variations in said analog signal and generating a CDS signal;
an analog to digital converter (ADC) for converting said CDS signal to a digital signal; and
a filter, wherein said filter subtracts values therefrom in proportion to predetermined weighted values.

11. The system of claim 10, wherein said filter boosts high frequency noise.

12. The system of claim 10, wherein said filter is an inverse filter.

13. The system of claim 10, wherein said filter is a Weiner filter.
